(19) United States
(12) Patent Application Publication
(10) Pub. No.: US 2025/0386835 A1
(43) Pub. Date: Dec. 25, 2025

(54) METHOD FOR REDUCING HARDNESS IN PROTEIN BARS

(71) Applicant: GLANBIA NUTRITIONALS LIMITED, Kilkenny (IE)

(72) Inventors: Robert Peterson, Twin Falls, ID (US); Jason Demmerly, Twin Falls, ID (US)

(73) Assignee: GLANBIA NUTRITIONALS LIMITED, Kilkenny (IE)

(21) Appl. No.: 18/992,538

(22) PCT Filed: Jul. 14, 2023
(86) PCT No.: PCT/US2023/027830

§ 371 Date: Jan. 8, 2025

Related U.S. Application Data
(60) Provisional application No. 63/389,379, filed on Jul. 15, 2022.

(51) Int. Cl. A23C 21/02; A23C 21/06; A23L 33/19

(52) U.S. Cl. CPC A23C 21/026; A23C 21/06; A23L 33/19; A23C 2220/20

(57) ABSTRACT

Disclosed is a method for making nutritional bars, especially high-protein nutritional bars, which exhibit reduced bar hardening over storage time, and products made by the method. The method also provides high-protein powders which can be used in bar formulations and a variety of other uses. The method combines pasteurization conditions and acidification by fermentation, addition of acid, or both, to provide a modified protein that is ideal for use in protein bars and reduces the tendency of those bars to harden over time.

### RELATED APPLICATIONS

This application claims the benefit of priority under 35 U.S.C. § 119 (e) of U.S. Provisional Application Ser. No. 63/389,379, filed on Jul. 15, 2022, the entire contents of which are incorporated herein by reference.

### FIELD OF THE INVENTION

The invention relates to methods for producing protein powders, including powdered yogurt, compositions made by the methods, and methods for using those powders to produce high-protein nutritional bars with extended shelf life and high-quality protein content.

### BACKGROUND OF THE INVENTION

The global market for protein-based nutritional bars is reported to have been 4.66 billion (USD) in 2019, and is expected to reach 7.03 billion (USD) by 2027. Consumers have continued to demonstrate a preference for ready-to-eat foods, meal replacements, and other convenience foods that can provide nutritional benefits, increasing the demand for protein bars. Bulk sales can provide a volume discount to retailers and consumers, but can involve storing product for longer periods of time before being consumed. Shelf life can therefore be an important factor in the nutritional and commercial value of protein bar formulations. Over storage time, hardening and texture changes such as the development of undesirable crumbly texture result in decreased potential shelf life. Reducing hardening and maintaining texture during storage time can therefore increase shelf life, resulting in decreased product losses in a multi-billion-dollar product line.

High-protein bars are usually made of about 30 percent fat, 30 percent protein powder, and 40 percent carbohydrate syrup, along with minor components that may include flavorings, stabilizers, and inclusions such as peanuts and fruit. The protein source is usually selected from either whey protein isolate (WPI), whey protein concentrate (WPC), or a protein blend, which may also contain hydrolyzed whey protein. Initially, this ingredient combination produces dough that is soft, malleable, and easily formed into bars. However, the onset of hardening in high-protein nutritional bars begins fairly soon after they are made. Immediately after manufacture, most nutritional bars have a soft nougat-like texture, but after a one-month storage at room temperature the bars will harden to some degree—and after four to six months the bars will generally become hard enough to make them difficult to chew. Generally, the higher the protein level in high-protein nutritional bars, the faster they harden to an unacceptable degree. Hardening results in consumer rejection of the product and, at this point, the product is generally discarded, resulting in a loss to the consumer, the manufacturer, or the retailer.

Various optional ingredients, processing steps, etc., have been utilized in an effort to minimize bar hardening. Much of the work has focused on the protein ingredients. For example, some formulators use hydrolyzed proteins almost exclusively. However, hydrolyzed proteins generally cost more than WPI or WPC, and their use can create quality issues such as bitter off-flavors and negative textural changes. Furthermore, the benefit of using hydrolyzed protein in bars can also be lost if the ingredients are overmixed and the proteins tend to lose their softening effect. Bars containing hydrolyzed protein also tend to stick to equipment, making them harder to process.

Milk protein concentrates (MPCs) contain the two protein fractions (casein and whey proteins) commonly used in formulating high protein bars. MPCs provide the nutritional advantages of both the casein and whey protein fractions of milk, and they have the highest digestible indispensable amino acid score (1.18—an indication of high protein quality). Although MPCs provide the full benefit of milk proteins, bars formulated with MPCs also tend to harden and have reduced shelf-life. Bars with high MPC content also tend to lack cohesiveness and can be too crumbly. One approach that has been used to reduce hardening has been the use of extruded milk protein concentrates, the extrusion process texturizing the globular proteins by shearing and stretching them into fibrous bundles. This results in denaturation of the protein. Banach et al. reported that “[h]igh-protein nutrition bars formulated with extruded MPCS0s hardened slower than those formulated with toasted or unmodified MPCS0” (Banach, J. C., Clark, S., and Lamsal, B. P., Microstructural Changes in Model High-protein Nutrition Bars Formulated with Modified Milk Protein Concentrates, Journal of Food Science (2016), 81(2): C332-C340). However, the use of a protein source with a higher content of native (undenatured) protein, can provide some nutritional benefits over that of denatured proteins. For example, 20 g of native whey induced a significantly significantly faster increase and higher peak values in blood leucine concentrations than 20 g of MWP, WPH, WPC-80 and milk after a bout of strength training (Hamarsland, H., Native whey induces higher and faster leucinemia than other whey protein supplements and milk: a randomized controlled trial, BMC Nutrition (2017) 3:10). Based on studies in mice, native whey has also been proposed to promote an improved immune response and higher glutathione levels than does denatured whey (Bounous, G. et al. The Biological Activity of Undenatured Dietary Whey Proteins: Role of Glutathione, Clin. Invest. Med. (1991) 14:296-309. Protein bars are often consumed by athletes and others looking for the nutritional benefits that the added protein can provide, so this can be an important consideration.

What are needed, then, are better methods for formulating nutritional bars with more complete, high-quality proteins while reducing the rate of bar hardening over time, providing both improved nutritional benefits and increased shelf-life.

### SUMMARY OF THE INVENTION

The invention relates to a method for making a powdered acidified protein product that can be incorporated into shelf-stable nutritional bars to improve protein quality and bar texture, the method comprising the steps of: forming a protein slurry comprising milk protein by admixing at least one liquid ingredient and at least one powdered ingredient to give a protein slurry having a whey/casein ratio of from about 20:80 to about 90:10; heat-treating the protein slurry using a high-efficiency heating system and pasteurization conditions that maintain at least about 75 percent of the protein in the slurry in its undenatured state; acidifying the protein slurry by a method selected from the group consisting of fermenting the protein slurry using at least one bacterial culture, adding at least one acid to the protein slurry, and combinations thereof, to produce an acidified protein slurry; and drying the acidified protein slurry to provide a powdered acidified protein product. In various aspects, the liquid ingredients are selected from the group consisting of fluid milk, skim milk, water, and combinations thereof. In various aspects, the powdered ingredients are selected from the group consisting of whey protein concentrate, whey protein isolate, milk protein concentrate, milk protein isolate, and combinations thereof. In various aspects, the total protein content in the acidified slurry is at least about 12 percent.

In various aspects of the method, the amount and ratio of protein in the protein base is adjusted to modulate the viscosity of the fermented and/or acidified product in a range from thin-to-thick.

In various aspects, the invention provides a method for decreasing hardness in a high-protein nutritional bar, the method comprising adding to at least one nutritional bar formulation at least one conditioning agent comprising a protein product which has been produced by forming a protein slurry from the admixture of at least one liquid ingredient selected from the group consisting of fluid milk, skim milk, water, and combinations thereof and at least one powdered ingredient selected from the group consisting of whey protein concentrate, whey protein isolate, milk protein concentrate, milk protein isolate, and combinations thereof; heat-treating the slurry using a high-efficiency heating system and pasteurization conditions that maintain at least about 75 percent of the whey protein base in its undenatured state; acidifying the slurry base by a method selected from the group consisting of fermenting the slurry using at least one bacterial culture, adding at least one acid to the slurry, and combinations thereof, to produce an acidified protein slurry; and drying the acidified protein slurry to provide a powdered acidified protein product. In various aspects, the total protein content in the acidified slurry is at least about 12 percent, and in various aspects, the step of drying is performed by spray-drying.

The invention also provides a protein bar composition, the composition comprising at least one fat, at least one carbohydrate syrup, and at least one protein component comprising an acidified protein product which has been produced by forming a protein slurry from the admixture of at least one liquid ingredient selected from the group consisting of fluid milk, skim milk, water, and combinations thereof and at least one powdered ingredient selected from the group consisting of whey protein concentrate, whey protein isolate, milk protein concentrate, milk protein isolate, and combinations thereof; heat-treating the slurry using a high-efficiency heating system and pasteurization conditions that maintain at least about 75 percent of the whey protein base in its undenatured state; acidifying the slurry base by a method selected from the group consisting of fermenting the slurry using at least one bacterial culture, adding at least one acid to the slurry, and combinations thereof, to produce an acidified protein slurry; and drying the acidified protein slurry to provide a powdered acidified protein product.

### BRIEF DESCRIPTION OF THE DRAWINGS

FIG. 1 is a graph of bar hardness (Y axis, force in grams) over time (X axis, days equivalence, accelerated storage) of 4 high-protein nutritional bars made using commercially-available yogurt powders (dashed lines) and 5 high-protein nutritional bars made by the method of the invention (using yogurt powders made from milk treated under pasteurization conditions that maintain at least about 75 percent of the whey protein in its undenatured state) (solid lines).

FIG. 2 is a graph of bar hardness (Y axis, force in grams) over time (X axis, days equivalence, accelerated storage) of 4 high-protein nutritional bars made using protein powders specifically formulated for use as ingredients in protein bars (dashed lines) and 3 high-protein nutritional bars made by the method of the invention (using powders made from a proteins base treated under pasteurization conditions that maintain at least about 75 percent of the whey protein in its undenatured state) (solid lines).

FIG. 3 is a graph of bar hardness (Y axis, force in grams) over time (X axis, days equivalence, accelerated storage) of 6 high-protein nutritional bars made using 6 different sets of ingredients. Compared were ingredient mixes comprising 30% protein and 20% fat. Mix 1 contained protein powder (Provon® 190, Glanbia Nutritionals, Inc.), Mix 2 replaced 5% of the protein powder with YP (yogurt powder made from milk treated under pasteurization conditions that maintain at least about 75 percent of the whey protein in its undenatured state), Mix 3 replaced 15% of the protein powder with YP, Mix 4 replaced 25% of the protein powder with YP, Mix 5 replaced 50% of the protein powder with YP, and Mix 5 replaced 75% of the protein powder with YP. As illustrated, bar hardness over time decreased with increased use of YP.

FIG. 4 is a graph of bar hardness (Y axis, force in grams) over time (X axis, days equivalence, accelerated storage) of 4 high-protein nutritional bars made using 4 different sets of ingredients. Acidified products were made using lactic acid. YP11-X had no acid added. The other samples; YP11-6, YP11-5, and YP11-4.6, were all reduced to a pH of 6.0, 5.0, and 4.6 respectively. As illustrated, softer bars were made while achieving a yogurt pH with direct acidification, similar to that produced by fermentation.

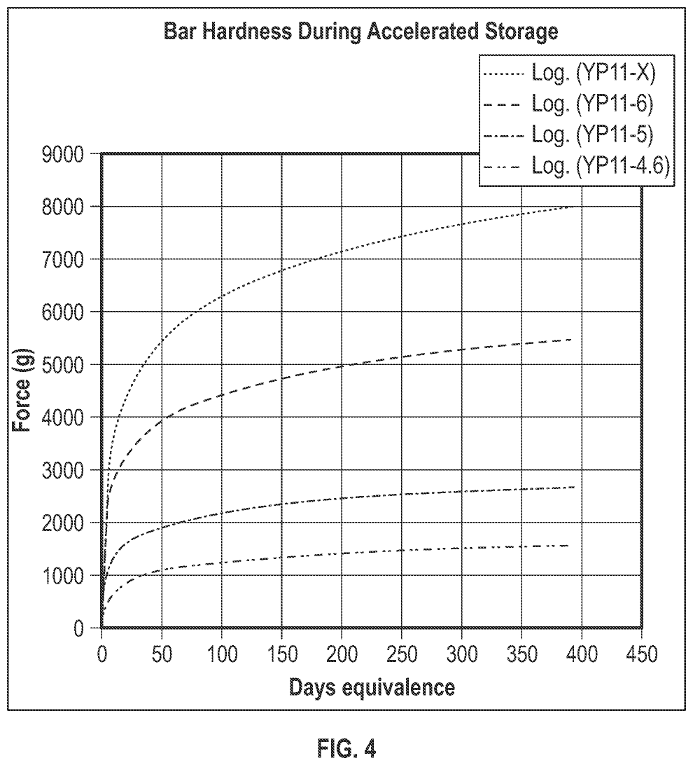

### DETAILED DESCRIPTION

The invention relates to a method for making protein powders which can be incorporated into shelf-stable nutritional bars to improve protein quality and bar texture, and decrease bar hardening over time, the method comprising heat-treating a protein slurry having a whey/casein ratio of from about 20:80 to about 90:10, the heat-treatment being performed using a high-efficiency heating system and pasteurization conditions that maintain at least about 75 percent of the whey protein in the slurry in its undenatured state, acidifying the protein slurry by a method selected from the group consisting of fermenting the protein slurry using at least one bacterial culture, adding at least one acid to the protein slurry, and combinations thereof, to produce an acidified protein slurry, and drying the acidified protein slurry to provide a powdered acidified protein product. In various embodiments, the protein slurry, acidified protein slurry, and/or powdered protein product comprises added flavoring. In various embodiments the step of drying is performed by spray-drying.

In various aspects, the protein slurry is made by a method comprising adding to a milk base selected from the group consisting of milk, milk protein concentrate, milk protein isolate, and combinations thereof at least one protein-containing component selected from the group consisting of at least one casein-containing component, at least one whey protein-containing component, and combinations thereof, to produce a protein base and give a whey/casein ratio of from about 20:80 to about 90:10 in the protein base. In various aspects of the invention, the addition of the at least one protein-containing component results in a total protein content in the acidified slurry of at least about 12 percent, and the amount and ratio of a protein-containing component that is added to the protein slurry is adjusted to modulate the viscosity of the fermented and/or acidified product in a range from thin-to-thick. In various aspects, the protein-containing component is selected from the group consisting of milk, cream, skim milk, WPC, WPI, MPC, MPI, non-fat dry milk (NFDM), UF milk, and combinations thereof.

The invention also relates to a method for decreasing hardness in a high-protein nutritional bar, the method comprising adding to at least one nutritional bar formulation at least one conditioning agent comprising a protein product which has been produced by forming a protein slurry comprising milk protein and added whey protein, heat-treating the protein slurry using a high-efficiency heating system and pasteurization conditions that maintain at least about 75 percent of the whey protein base in its undenatured state, acidifying the protein slurry by a method selected from the group consisting of fermenting the protein slurry using at least one bacterial culture, adding at least one acid to the protein slurry, and combinations thereof, to produce an acidified protein slurry, and drying the acidified protein slurry to provide a powdered acidified protein product.

The invention also relates to a protein bar composition, the composition comprising at least one fat, at least one carbohydrate syrup, and at least one protein component comprising acidified protein powder which has been produced by drying an acidified protein slurry made from a protein slurry comprising milk protein with added protein (e.g., whey protein) that has been heat-treated under pasteurization conditions that maintain at least about 75 percent of the whey protein in the protein base in its undenatured state, wherein the acidified protein slurry is made by fermenting the protein slurry using at least one bacterial culture, adding at least one acid to the protein slurry, and combinations thereof, to produce an acidified protein slurry.

Yogurt is generally produced by fermenting milk with bacterial cultures consisting of a mixture of Streptococcus subsp. thermophilus and Lactobacillus delbrueckii subsp. bulgaricus, which are added to the yogurt milk after it is heat-treated. Heat-treatment kills pathogenic bacteria and non-pathogenic bacteria that might compete with the bacteria in the starter culture. Standard heat-treatments also denature whey proteins, resulting in crosslinking of the whey proteins with caseins to form the yogurt gel. The heating step is therefore considered to be critical for the formation of the viscoelastic gel that transforms yogurt milk into yogurt. The temperatures required to produce protein denaturation are higher than those that are minimally-required to kill bacteria, resulting in an industry standard has been to use higher temperatures and temperature/time combinations that are targeted to denature the protein. Temperature/time combinations for the pasteurization step commonly used in the yogurt industry include 85° C. for 30 minutes, or 90-95° C. for 5 minutes. Sometimes, very high temperature short time (100° C. to 130° C. for 4 to 16 seconds) or ultra-heat temperature (UHT) (140° C. for 4 to 16 seconds) are used. However, a method for making yogurt which can contain significantly higher amounts of protein has been disclosed by Christiansen in PCT publication number WO2021/119543A1.

The present inventors have discovered that yogurt powder and/or protein powder formed from an acidified protein base, produced using the same minimal pasteurization temperatures, which leave at least about 75 percent of the protein in the protein base in a substantially undenatured state, can be powdered and used as either the sole source of protein in a protein bar or as a conditioning agent, added to the protein ingredient(s) in a protein bar formulation, to extend the shelf-life of the protein bar by decreasing hardening of the bar over time. This would generally be counterintuitive and unexpected, give the previous reports of the efficacy of denatured protein to reduce bar hardening, the improved properties of bars made with whey protein as compared to those of bars made with milk protein concentrate-since yogurt contains both casein and whey proteins, as does milk protein concentrate, and the superior results provided by extruded milk protein concentrate as compared to those of non-denatured milk protein concentrate. However, the inventors have demonstrated that when yogurt protein made from at least one acidified protein slurry that has been produced from a protein base that has been pasteurized under minimal pasteurization conditions is used as a bar ingredient, it produces a very significant decrease in bar hardening over time as compared to that of whey protein isolate and commercially-available yogurt powders which are produced under standard pasteurization conditions used for yogurt-making that denature most of the protein in the yogurt milk.

Furthermore, it is unexpected that there would be differences between the different heating profiles. In the inventors' studies, however, they determined that high-protein bars made using commercially available yogurt powders are dry and powdery, even at lower levels of protein, and bars formulated with yogurt powders made by the inventors using batch pasteurization tended to have familiar issues with hardening over time. Their observations confirm that the combination of heating method and acidification, whether the acidification is achieved by fermentation, by the addition of acid, or both, produces a product that has significantly better properties for its use in protein bar formulations-providing both high-quality protein in a more native state and decreased levels of bar hardening over time.

“Yogurt” is defined by the United States Food and Drug Administration as a product that is produced by culturing dairy ingredients using lactic acid-producing bacteria. Dairy ingredients for yogurt production comprise cream, milk, partially skimmed milk, skim milk, and combinations thereof. Other optional ingredients include, for example, concentrated skim milk, nonfat dry milk, buttermilk, whey, lactose, lactalbumins, and lactoglobulins. “Native protein(s)” and “undenatured protein(s)” may be used interchangeably herein, both referring to proteins that are relatively unaltered by denaturation due to the heat used in pasteurization/heat treatment. A bar “formulation” is the combination of ingredients, which can be represented by a list of ingredients, which are combined to produce a nutritional bar such as a high-protein nutritional bar. Bar “hardness” is a measure of the force required to penetrate the surface of the bar-similar to that required to bite into a protein bar. Hardness can be expressed in Newtons (with 12 Newtons generally being the level at which unacceptable bar hardness occurs), but is often expressed in grams. “Accelerated storage conditions” were used by the inventors to assess hardening over time and stability/shelf-life. Such conditions are accepted in the industry as appropriate for determining product attributes as they would change over an extended time. “In accelerated stability tests, a product is stored at elevated stress conditions (such as temperature, humidity, and pH). Degradation at the recommended storage conditions can be predicted using known relationships between the acceleration factor and the degradation rate.” (Haouet, M. N., Experimental accelerated shelf life determination of a ready-to-eat processed food, Ital J Food Saf. 2018 Dec. 31; 7(4): 6919).

Acidfied protein slurries for drying to powders for use in the method of the invention are processed under pasteurization conditions that promote the maintenance of the whey proteins in their native state. Pasteurization conditions can include minimum pasteurization temperatures for appropriate holding times, flash pasteurization (high temperature, short time, 166° F. for 15 seconds), or higher heat shorter time (HHST, 194° F. for 0.5 seconds), for example. The inventors have discovered that pasteurization produced using heating systems that provide high-efficiency heating to accomplish the pasteurization at high heat for a short period of time (e.g., less than about 1 minute) gives a product that has less denatured protein, yet provides a modification that makes the dried protein powder, having both casein and whey proteins in it, a protein source that, when added to protein bar formulations, decreases bar hardening over time and extends the shelf-life of the resulting protein bars.

In the method of the invention, a protein base can be fermented to form a yogurt powder by combining the protein base and any additional ingredients, homogenizing the combination, and cooling to fermentation temperatures of 95-112° F. (about 42° C.). Bacterial starter culture is added, and the mixture is fermented to a final pH of 4.3 to 4.75, then stirred, sheared and cooled to 35-50° F. Alternatively, an acidified protein product can be made by combining the protein base and any additional ingredients, homogenizing the combination, and cooling, then adding one or more acids directly. Starting from a pH about 6.7-6.9, the pH is lowered by adding acid until a pH of 4.2-4.8 is achieved.

Minimum pasteurization conditions are known to those of skill in the art of dairy food production. These conditions are generally the minimum processing conditions needed to kill Coxiella burnetii, the organism that causes Q fever in humans. C. burnetii is the most heat-resistant pathogen currently recognized in milk. In the United States, for example, the Pasteurized Milk Ordinance (PMO) mandates the conditions which must be met in order to achieve minimum pasteurization conditions. Pasteurization, however can be achieved with minimal levels of denaturation of the important proteins that can be found in milk-5 percent or less of the whey protein, for example—although because of the general consensus that denaturation of whey protein (especially beta-lactoglobulin) is necessary for yogurt processing and the formation of yogurt gels, it has been customary in the industry to use pasteurization conditions that are designed to result in protein denaturation, although they are not required by the PMO. The inventors have discovered that acidified products made without denaturing a significant amount of the whey protein (i.e., leaving at least about 75% of the protein in its undenatured state) can be used to produce proteins for use as ingredients in the formulation of nutritional bars, including high-protein nutritional bars. Table 1 lists some temperature/time combinations that have been shown to be effective for killing pathogenic bacteria (C. burnetii) in milk. If the milk product is concentrated (condensed), the temperature is increased by 3° C. (5° F.). (Source: International Dairy Foods Association (IDFA), https://www.idfa.org/news-views/media-kits/milk/pasteurization.) Combinations of time and temperature that result in the destruction of pathogens without permanently denaturing the milk proteins can therefore be identified and selected by those of skill in the art.

TABLE 1
Temperature and Time Combinations
for Milk Product Pasteurization

| Temperature | Time | | Pasteurization Type |
|---|---|---|---|
| 161° F. | 15 | seconds | High temperature short time |
| | | | Pasteurization (HTST) |
| 191° F. | 1.0 | second | Higher-Heat Shorter Time (HHST) |
| 194° F. | 0.5 | seconds | Higher-Heat Shorter Time (HHST) |
| 201° F. | 0.1 | seconds | Higher-Heat Shorter Time (HHST) |
| 204° F. | 0.05 | seconds | Higher-Heat Shorter Time (HHST) |
| 212° F. | 0.01 | seconds | Higher-Heat Shorter Time (HHST) |
| 280° F. | 2.0 | seconds | Ultra-Pasteurization (UP) |

Liquid ingredients (fluid milk, skim milk, water) and protein ingredients (WPC, WPI, MPC, MPI) can be combined and mixed at from about 85 to about 95 degrees Fahrenheit to produce a slurry, or protein base. Other ingredients, such as pectin, sugars, flavors can also be added at this point. The resulting slurry is heat-treated using the times and temperatures selected to accomplish the destruction of generally-known types of pathogenic bacteria, while avoiding permanent denaturation of the proteins. In one embodiment of the method, the heat-treated slurry is cooled to a temperature of from about 95 to about 112° F. and inoculated using lactose-fermenting, yogurt-producing cultures. The inoculated slurry is cultured for a period of from about 4 to about 16 hours, and even more preferably from about 5 to about 8 hours. When a pH of from about 5.0 to about 4.0 is reached, the resulting acidified protein slurry is stirred to break the set, and the acidified protein slurry is spray-dried with an inlet temperature of from about 235 to about 245° C. and an outlet temperature of from about 90 to about 95° C. to produce yogurt protein powder (YP). It should be noted that spray-drying is easier with slurries that are less viscous.

In the method of the invention, acidified protein produced under these conditions can be used as an ingredient in nutritional bars to reduce hardening over time and increase their shelf-life. Incorporation of the yogurt powder as in the method of the invention can also improve the texture of the resulting product. Another advantage provided by the method is that the pasteurization conditions of the protein base allow for more protein to be incorporated into the final product, increasing the amount of protein that can be incorporated into the resulting bars into which the acidified protein powder is incorporated. Acidified protein powder made by the method of the invention can comprise from about 60 percent protein to about 95% protein. For bar formulations, however, the inventors have determined that the standard 80+ percent (e.g., about 83%) protein produces optimal results. Briefly, bars can be made by combining desired syrups, fats and flavors and mixing until fully mixed. Then, dry ingredients, such as protein, are mixed with the liquids to form a dough that can be formed into bars.

Yogurt powder made by conventional methods has been used in bar formulations, but does cause undesirable hardening and crumbly texture. However, the taste is not undesirable. Where a more neutral, less acidic-tasting protein powder is desired, the inventors have discovered that the culture ingredients can be modified to provide a more neutral-tasting powder. Using a galactose-positive culture results in achieving the pH necessary to produce the yogurt, while resulting in a milder yogurt protein flavor.

In the method of the invention, liquid ingredients (e.g., fluid milk, skim milk, water) can be gently warmed to 85-95°. Powdered ingredients (e.g., WPC, WPI, MPC, MPI) are added and mixed into the liquid ingredients to give a yogurt base. Gentle mixing is used for from about 30 minutes to allow the proteins to fully homogenize in the water. By using high/higher temperature, short time pasteurization done with heat plate exchangers, the inventors have discovered that acidified protein slurries can be produced that are thin (i.e., less viscous), while still maintaining a high protein load. Drying this acidified protein slurry produces a protein powder having excellent functionality in protein bars. The protein base is heated to from about 90° F. to about 166° F. for 30 seconds using a high-efficiency heating apparatus, then cooled to a range of 95-112° F.

Bacterial cultures are added to the protein base, thoroughly mixed, and the inoculated yogurt base is held at from about 95° F. to about 112° F. until a pH of 4.0-5.0 is achieved. The inoculated protein base is further cooled to around 50° F. and one or more acid is added dropwise, until the desired pH (about 4.6) is achieved. The acid can be, for example, an acid such as lactic acid.

The resulting acidified protein slurry is spray-dried using conventional methods known to those of skill in the art for making dried yogurt powder from yogurt.

The inventors have, for example, compared the results for yogurt powders produced using batch pasteurization and pasteurization performed using a plate heat exchanger, and discovered that yogurt powders produced in the method of the invention using a plate heat exchanger (a high-efficiency heating apparatus) give exceptional results when used in formulating high-protein nutritional bars. A plate heat exchanger, for example, is a high-efficiency heating apparatus that uses metal plates to transfer heat between two fluids. The advantage that this provides is that the fluids are exposed to a much larger surface area because they are spread out over the plates, facilitating the heat transfer and significantly increasing the speed of the temperature change. The batch method uses a vat pasteurizer which consists of a jacketed vat surrounded by either circulating water, steam, or heating coils filled with water or steam. In the vat the milk is heated to about 65° C. (150° F.) and held for 30 minutes, followed by rapid cooling. During the holding period, agitation is usually applied to improve heat distribution. However, the surface area over which the heat is applied in batch pasteurization is significantly less than the surface area over which the heat is applied in a plate heat exchanger. The inventors have discovered that increased heating efficiency, providing more rapid overall heating, appears to produce an impact on the properties of the protein in the resulting powder.

Bars made using protein powders made by the method of the invention are soft, cohesive, and chewy, and use of the yogurt powder maintains that texture far better than that of whey proteins and milk proteins, generally. Bars generally include carbohydrates, which can be in the form of syrup, sugar alcohol, fiber, etc., or a combination thereof. They also generally include fat, which can be in the form of one or more oil (solid, such as vegetable shortening, coconut, palm, etc., or liquid, such as canola, olive, sunflower, etc. oil, or any of a number of nut butters.

Although the protein composition of yogurt powder is similar to that of milk protein concentrate, previous efforts by others to improve storage stability of high-protein bars by cross-linking MPC using transglutaminase, calcium reduction (including by the addition of acid to the MPC), and toasting were unsuccessful. However, the present method, combining the use of minimum pasteurization conditions performed by a high-efficiency heating method with acidification by fermentation, by the addition of acid, or both, produces a powdered product containing both casein and whey proteins that provides good initial texture, maintains good texture over time, and decreases hardening over storage time when added to nutritional bar formulations.

Where the term “comprising” is used, it should be understood that the terms “consisting of” and “consisting essentially of” can also be used to more narrowly define the scope of what is claimed.

The invention will now be described by means of the following non-limiting examples.

### EXAMPLES

Liquid ingredients (fluid milk and water) and protein ingredients (WPC, WPI, MPC, MPI) were combined and mixed at 90° F. for 30 minutes. The resulting slurry was then heated using the times and temperatures shown in Table 2.

TABLE 2
Pasteurization (Heat Treatment) Times and Temperatures

| | |
|---|---|
| HTST 166° F. | 15 sec |
| HHST 194° F | 0.5 sec |

The product was then cooled to 108° F. and inoculated using a cocktail of cultures including xc-11 (Chr Hansen) and Ultra-Gro Direct (DSM). The inoculated mix was cultured for 5-8 hours. The product was stirred when a pH of 4.65 was achieved. After stirring to break the set, the product was spray dried with an inlet temperature of 235-245° C. and an outlet temperature of 90-95° C. to produce yogurt powder (YP).

TABLE 3
Ingredients - Yogurt Powders

| Sample | |
|---|---|
| ID | Formula |
| YP1 | 84.49% whole milk, 2.50% MPC 85, 0.50% Pectin 383, |
| | 12.50% Optisol ® 1092, lyophilized Culture 0.01% |
| YP2 | 84.49% whole milk, 2.50% MPC 85, 0.50% Pectin 383, |
| | 12.50% Optisol ® 1092, lyophilized Culture 0.01% |
| YP3 | 77.48% Skim milk, 2.50% MPC85, 20.00% Provon ® 190, |
| | 0.02% Culture (xc 11) |
| YP4 | 77.48% Whole Milk, 2.50% MPC85, 20.00% Provon ® 190, |
| | 0.02% Culture (xc 11) |
| YP5 | 77.48% Skim milk, 2.50% MPC85, 20.00% Provon ® 190, |
| | 0.02% Culture (xc 11) |
| YP6 | 83.73% Skim milk, 2.5% MPI, 13.75% Provon ® 190, |
| | 0.02% Culture (xc11) |
| YP7 | 40% Skim milk, 42.06% Water, 4.17% MPI, 13.75% Provon ® |
| | 190, 0.02% Culture (xc11) |
| YP8 | 20% Skim milk, 61.29% Water, 4.94% MPI, 13.75% Provon ® |
| | 190, 0.02% Culture (xc11) |
| YP8+ | 20% Skim milk, 61.27% Water, 4.94% MPI, 13.75% Provon ® |
| | 190, 0.02% Culture (xc11), 0.02% Adiunct Culture (Ultra-Gro) |
| YP11 | 20% Skim milk, 61.29% Water, 4.94% MPI, 13.75% Provon ® |
| | 190 |

TABLE 4
Analytical results of YP samples

| Sample | YP1 | YP2 | YP3 | YP4 | YP5 | YP6 | YP7 | YP8 | YP8+ |
|---|---|---|---|---|---|---|---|---|---|
| pH | 4.38 | 4.41 | 4.51 | 3.78 | 4.06 | 4.25 | 4.44 | 4.88 | 4.68 |
| Moisture % | 3.66 | 4.09 | 4.37 | 3.4 | 4.72 | 5.20 | 5.00 | 4.77 | 4.04 |
| Lactose | 12.3 | 13 | 14.8 | 8.14 | 9.03 | 12.70 | 6.08 | 3.48 | 1.32 |
| Protein % (as | 61.7 | 61 | 69.6 | 70.3 | 76.3 | 70.40 | 78.20 | 82.80 | 83.3 |
| is) | | | | | | | | | |
| Ash % | 4.28 | 4.3 | | | | 4.80 | 4.45 | 4.25 | 3.88 |
| Lipids % | 10.52 | 10.15 | 0.42 | 8.07 | 0.43 | 0.22 | 0.17 | 0.17 | 0.32 |
| Carbs % | 19.84 | 20.46 | 21.1 | 14.4 | 14.5 | | | | 8.46 |
| (by diff.) | | | | | | | | | |
| Carbs % | | | | | | 10.4 | 4.5 | 2.94 | |
| (by Phenol) | | | | | | | | | |
| Nitrogen | 32.3 | 32.0 | | | | | | | |
| solubility @4.6 | | | | | | | | | |
| Nitrogen | 57.0 | 55.6 | | | | | | | |
| solubility @6.6 | | | | | | | | | |
| Dia (um) | 19.23 | 22.29 | 14.42 | 158.9/22.86 | 40.6 | | | | |
| Vol % | 100 | 100 | 100 | 22.2/77.8 | 100 | | | | |
| width | 27.41 | 34.72 | 28.19 | 127.1/40.8 | 100 | | | | |

The powders (YPs), were made into model bars with light corn syrup and shortening. Bars were also made using Glanbia BarPro® 288, as well as four different commercially-available yogurt powders. The commercially-available yogurt powders are much lower in protein, ranging from 32-26% protein, w/w, while the YPs produced using non-denaturing pasteurization conditions contained higher amounts of protein.

In order to measure the actual functionality of the products, rather than the just the level of protein, model bars were made using the same protein and fat levels. Initially 25% protein, 20% fat was selected for the testing levels. For the 4 commercially available yogurt powders, these did not form bars. When attempting to achieve 25% protein, the result was a crumbly powder rather than a formable bar. Instead, these bars were made at 15% protein, 20% fat, to produce a dough soft enough to form into bars. At this level, the YP products made using non-denaturing pasteurization conditions (YP-ND) would be too soft to form a bar. This difference in softness/hardness translates into the ability to significantly increase the protein levels in bars made using YP-ND as compared to bars made using commercially-available yogurt powders.

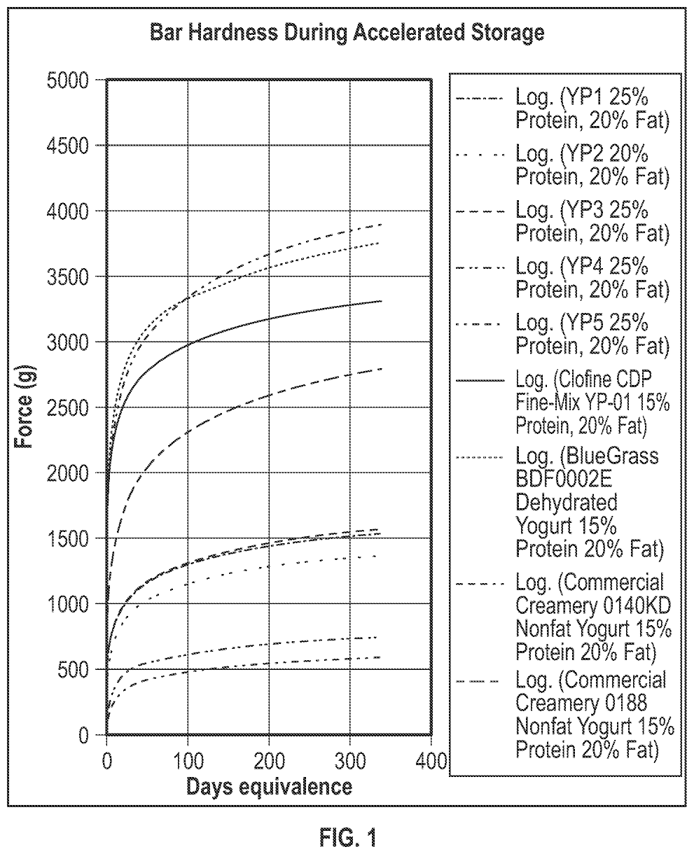

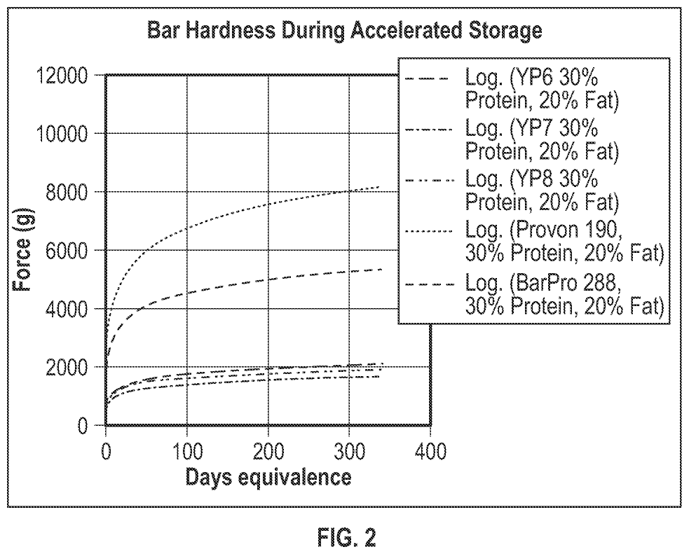

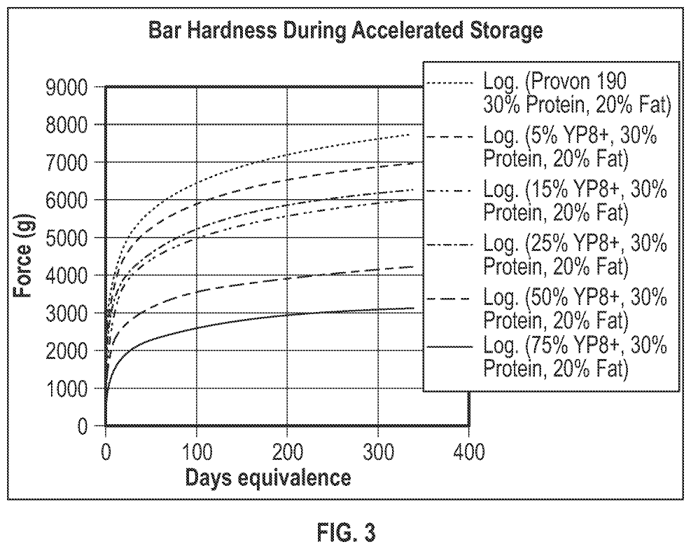

The bars were placed into accelerated storage and tested weekly on a texture analyzer for hardness. The results are shown FIG. 1, FIG. 2, and FIG. 3. Compared to commercially available yogurt powders, the inventors noted a drastic improvement in shelf-stability, as determined by decreased bar hardness. When compared to other protein compositions formulated to provide bar solutions, all made by Glanbia Nutritionals, Inc. (FIG. 2), YP-ND products are still softer, even at a 30% protein level in a bar.

Bars were made at equal protein and fat levels. Bars were also made with YPS+ at varying levels of inclusion, replacing Provon® 190, a whey protein isolate (Glanbia Nutritionals, Inc.), to determine the value of YP-ND at lower inclusion rates (i.e., as a conditioning agent, to reduce hardness in bars).

YP8+ was made with a cocktail of cultures, including a galactose-positive culture. This sample resulted in lower lactose levels and a milder flavor.

High-Temp, Short-Time Heat Treatment Using Heat Exchanger, in Combination with Direct Acidification

Water (8054 ml) was added to a large container and warmed to 85-95 F with agitation. Once warmed, MPI (571 g) and WPI (1375 g) are added and mixed for 30 minutes to allow for hydration. The slurry is then passed through a Microthermics® plate heat exchange, in which it is heated to 166 F, held for thirty seconds then cooled down to 95 F. After heating, the slurry is further cooled to around 50 F. While the product is being constantly stirred, lactic acid was added dropwise until a pH of 4.6 is achieved, over a duration of one hour, so as to avoid aggregation of the protein. When carefully done, this should result a slight increase in viscosity, but no detectable separation. In this example, roughly 1.0-1.4% of the final weight is lactic acid. The resulting product is then spray dried. Once dried, it is ready for use.

What is claimed is:

1. A method for making a powdered acidified protein product that can be incorporated into shelf-stable nutritional bars to improve protein quality and bar texture, the method comprising the steps of:
(a) forming a protein slurry comprising milk protein by admixing at least one liquid component and at least one powdered component to produce a protein slurry having a whey/casein ratio of from about 20:80 to about 90:10;
(b) heat-treating the protein slurry using a high-efficiency heating system and pasteurization conditions that maintain at least about 75 percent of the protein in the slurry in its undenatured state;
(c) acidifying the protein slurry by a method selected from the group consisting of fermenting the protein slurry using at least one bacterial culture, adding at least one acid to the protein slurry, and combinations thereof, to produce an acidified protein slurry; and
(d) drying the acidified protein slurry to provide a powdered acidified protein product.

2. The method of claim 1, wherein the at least one liquid component is selected from the group consisting of fluid milk, skim milk, water, and combinations thereof.

3. The method of claim 1, wherein the at least one powdered component is selected from the group consisting of whey protein concentrate, whey protein isolate, milk protein concentrate, milk protein isolate, and combinations thereof.

4. The method of claim 1, wherein the total protein content in the acidified slurry is at least about 12 percent.

5. The method of claim 1, wherein the amount and ratio of protein in the protein base is adjusted to modulate the viscosity of the fermented and/or acidified product in a range from thin-to-thick.

6. A method for decreasing hardness in a high-protein nutritional bar, the method comprising adding to at least one nutritional bar formulation at least one conditioning agent comprising a protein product which has been produced by
(a) forming a protein slurry from the admixture of at least one liquid ingredient selected from the group consisting of fluid milk, skim milk, water, and combinations thereof and at least one powdered ingredient selected from the group consisting of whey protein concentrate, whey protein isolate, milk protein concentrate, milk protein isolate, and combinations thereof;
(b) heat-treating the slurry using a high-efficiency heating system and pasteurization conditions that maintain at least about 75 percent of the whey protein base in its undenatured state;
(c) acidifying the slurry base by a method selected from the group consisting of fermenting the slurry using at least one bacterial culture, adding at least one acid to the slurry, and combinations thereof, to produce an acidified protein slurry; and
(d) drying the acidified protein slurry to provide a powdered acidified protein product.

7. The method of claim 6, wherein total protein content in the acidified slurry is at least about 12 percent.

8. The method of claim 6 wherein the step of drying is performed by spray-drying.

9. A protein bar composition, the composition comprising at least one fat, at least one carbohydrate syrup, and at least one protein component comprising an acidified protein product which has been produced by
(a) forming a protein slurry from the admixture of at least one liquid ingredient selected from the group consisting of fluid milk, skim milk, water, and combinations thereof and at least one powdered ingredient selected from the group consisting of whey protein concentrate, whey protein isolate, milk protein concentrate, milk protein isolate, and combinations thereof;
(b) heat-treating the slurry using a high-efficiency heating system and pasteurization conditions that maintain at least about 75 percent of the whey protein base in its undenatured state;
(c) acidifying the slurry base by a method selected from the group consisting of fermenting the slurry using at least one bacterial culture, adding at least one acid to the slurry, and combinations thereof, to produce an acidified protein slurry; and
(d) drying the acidified protein slurry to provide a powdered acidified protein product.
